(19) United States
(12) Patent Application Publication
(10) Pub. No.: US 2010/0019461 A1
(43) Pub. Date: Jan. 28, 2010

(54) LAYING NETWORK CABLES IN SEWERS

(75) Inventor: Elfed Thomas, Llandudno (GB)

Correspondence Address: BARLOW, JOSEPHS & HOLMES, LTD., 101 DYER STREET, 5TH FLOOR, PROVIDENCE, RI, 02903, US

(73) Assignee: H2O NETWORKS GROUP LIMITED, Haydock (GB)

(21) Appl. No.: 12/374,410

(22) PCT Filed: Jul. 20, 2007
(86) PCT No.: PCT/GB07/02788

§ 371 Date: Jul. 9, 2009

(30) Foreign Application Priority Data
Jul. 20, 2006 (GB) 0614416.6

(51) Int. Cl. F16L 21/05; E03F 3/06

(52) U.S. Cl. 277/603; 405/184

(57) ABSTRACT

In the present invention, a cable 105 is laid along sewer branch 101 to point B and then travels through a dedicated conduit directly to point C. As the cost of laying cable through a sewer can be cheaper and is usually less disruptive than laying cable in a dedicated conduit, the method of the present invention may reduce the cost of providing a cable link in situations such as A-C wherein a convenient sewer extends only part way between the cable end points.

The present invention relates to the laying of cables in sewers, and in particular to a means for enabling such cables to be laid along the flow channel at the bottom of the sewer.

In order to install a new hardwired network, it is necessary to provide cables linking the various nodes in the network. Often, this will require the cables to link nodes at one address with nodes at one or more different addresses. In order to minimise disruption caused by the laying of new cables, some network installers have taken to laying cables within sewer pipes rather than constructing dedicated conduits. This provides a convenient path for the cable that is relatively sheltered and can cost less than providing a dedicated conduit. Furthermore, providing a dedicated conduit would typically involve digging a trench for the conduit and filling the trench after installing the conduit, which causes considerable disruption to others, particularly if the cable is to be laid in an urban area.

In some locations, no convenient sewer travels between the points to be connected by a cable. In such cases, a cable may have to be travel via a circuitous route along the sewers to connect the two points. This increases costs in laying the cable (and in subsequently maintaining the cable) the network installer reverts to digging a dedicated conduit.

Even if there is a convenient sewer, once the cable reaches the desired location it must exit the sewer. Providing an exit path from the sewer for the cable typically also provides an exit path for fumes from the sewer. Such fumes are unpleasant and may be dangerous.

It is therefore an object of the present invention to alleviate or overcome the above problems.

According to a first aspect of the present invention there is provided a method of laying a cable between two points comprising the steps of: laying a cable through one or more lengths of sewer between the two points; and where there is no convenient length of sewer or a gap between convenient lengths of sewer, providing a length of dedicated cable conduit and laying said cable through said dedicated cable conduit.

By use of the above technique, cables can travel along sewers where possible minimising cost and disruption but for parts of a network wherein there is no convenient sewer, the cable may be laid in a dedicated conduit minimising the costs of laying and subsequently maintaining additional cable.

The cable may be laid through the sewer using any suitable technique. The techniques may include, but are not limited to: laying the cable loose in the flow channel of the sewer; pinning the cable to the walls of the sewer; or passing the cable through a duct provided in the sewer.

In embodiments wherein the method involves laying the cable loose in the flow channel of a sewer, the method may include the step of installing a suitable cable guide at points wherein the cable is desired or required to enter or leave the flow channel. The cable guide is preferably adapted to enable the cable to enter/exit the flow channel without significantly impeding the flow. The cable guide may comprise a body section and an arm section, the body section adapted to lie substantially flush with the wall of the flow channel and the arm section providing a passage for the cable between the flow channel and a point outside the flow channel. Such cable guides may be installed at points wherein the cable is required to enter or leave the sewer and on either side of points such as junctions or bends in the sewer wherein a cable in the flow channel is likely to lie across the direction of flow. In such areas, the cable may be laid outside the flow channel using any suitable other technique such as pinning the cable to the walls of the sewer; or passing the cable through a duct provided in the sewer.

In embodiments wherein the method involves passing the cable through a duct provided in the sewer, the method may involve the additional step of installing a suitable duct. In alternative embodiments, the duct may be pre-installed in the sewer at the time of constructing the sewer. The duct may be pinned or otherwise affixed to the walls or ceiling of the sewer. The duct may be substantially continuous between the cable entry point and the cable exit point or may be comprised of a plurality of separate sections having gaps therebetween.

The cable conduit may be provided by any suitable technique. Typically, this might involve digging a trench, laying the cable in the trench and filling the trench. The cable may be laid in ducting provided at the bottom of the trench. The trench may be filled in layers. In particular, the trench may be filled with a sand layer directly over the cable and a layer of hard core over the sand. A layer of concrete, tarmac, asphalt, bitumen or other suitable sealing/paving surface may be provided over the hardcore if required or desired. The method may further include laying a warning tape between the sand and the hard core layers. The warning tape is adapted to be detectable by the provision of a metal strip inlay and/or being printed with a visible warning. The provision of a metal strip allows the tape to be detected by the a scan of the area using an inductive detector. This may be routinely carried out prior to road excavation. The visible warning may comprise bright colours and/or distinctive patterns and/or a written warning message such as “Warning Fibre Cable”, or similar.

In one preferred embodiment, the trench may be cut and filled in line with the relevant provisions of the MCH 1540 (issue E) standard set by the UK Highways Agency for the installation of inductive loops in roads.

The cable may exit the sewer by any suitable means. Preferably, the cable will exit the sewer via a duct into the space below an access hatch or ‘manhole’.

Preferably, sealing means may be provided at points wherein the cable exits a sewer, to prevent the escape of noxious gases from the sewer. In some embodiments, sealing means may be provided at both ends of a duct carrying the cable between the sewer and the dedicated conduit.

In the above method, it is of course also possible for cables to be laid along the roadside drains and/or other types of storm drain in addition to or in place of cables laid along sewers.

According to a second aspect of the present invention there is provided a network comprising one or more cables laid in accordance with the method of the first aspect of the present invention.

The network may incorporate any or all of the features described in relation to the first aspect of the invention as desired or as appropriate.

The network can be used for any form of data. The cables within the network may be adapted to carry electrical or optical data signals and may thus be electrical data cables or fibre optic cables as required.

According to a third aspect of the present invention there is provided a sealing means for preventing the escape of noxious gases from a sewer at a point wherein a cable exits said sewer comprising: a body having an exterior adapted to fit the aperture through which the cable exits the sewer; and a passage through the body allowing the passage of said cable wherein the body is formed from a resiliently deformable material such that it forms a substantially air tight seal around the cable and a substantially airtight seal between the exterior of the body and the aperture.

One or both ends of the sealing means may be adapted to make it easier to insert a cable. This may be achieved by adapting one or both ends to provide a recessed stepped end portion, a projecting stepped end portion or any other suitable adaptation.

The sealing means may be adapted to fit a duct leading the cable away from the sewer. The sealing means may be retained in the duct with the aid of a suitable adhesive, such as an epoxy resin or similar. Preferably, the adhesive is adapted to cure within a time period of say, 1 hour or less. Most preferably, the adhesive is adapted to cure within a time period of say, 15 minutes or less. Advantageously, the adhesive is adapted to cure in the presence of water. The adhesive may also aid the formation of a substantially airtight seal.

The cable may be retained in the sealing means with the aid of a suitable adhesive, such as an epoxy resin or similar. Preferably, the adhesive is adapted to cure within a time period of say, 1 hour or less. Most preferably, the adhesive is adapted to cure within a time period of say, 15 minutes or less. Advantageously, the adhesive is adapted to cure in the presence of water. The adhesive may also aid the formation of a substantially airtight seal.

According to a fourth aspect of the present invention, there is provided a method of preventing the escape of noxious gases from a sewer at the point wherein a cable exits said sewer comprising installing a sealing means according to the third aspect of the present invention at the point wherein said cable exits said sewer.

The method may include any or all of the features of the sealing means of the third aspect of the present invention, as desired or as appropriate.

The sealing means and method of the third and fourth aspects of the present invention may be used in conjunction with the method of the first aspect of the present invention or the network of the second aspect of the present invention, as desired or as appropriate.

In order that the invention can be more clearly understood it is now described further below with reference to the accompanying drawings:

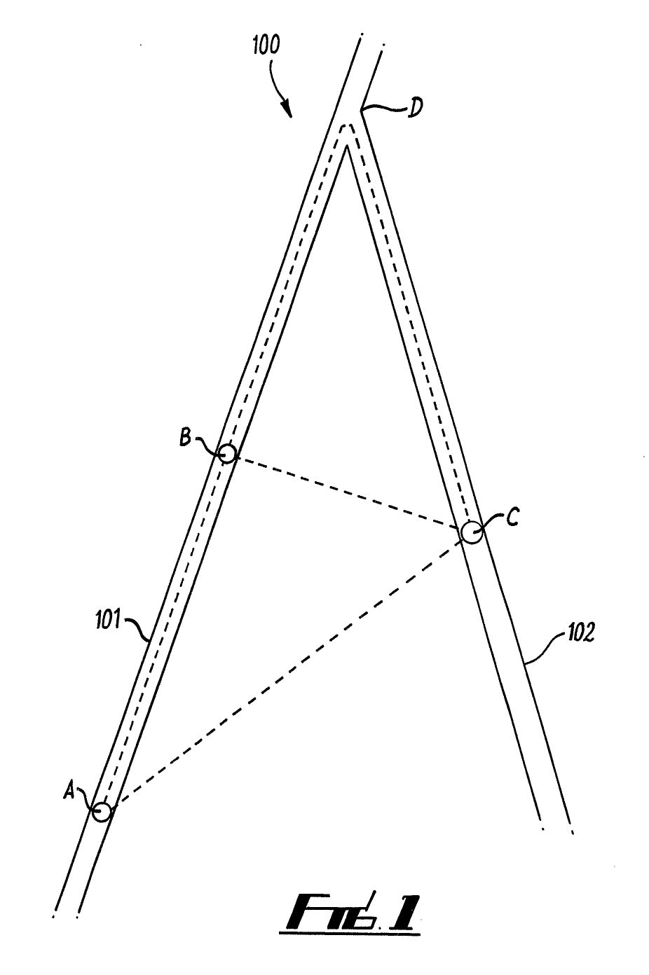

FIG. 1 is a schematic view of a plurality of locations that may be linked in a network using the method of the present invention;

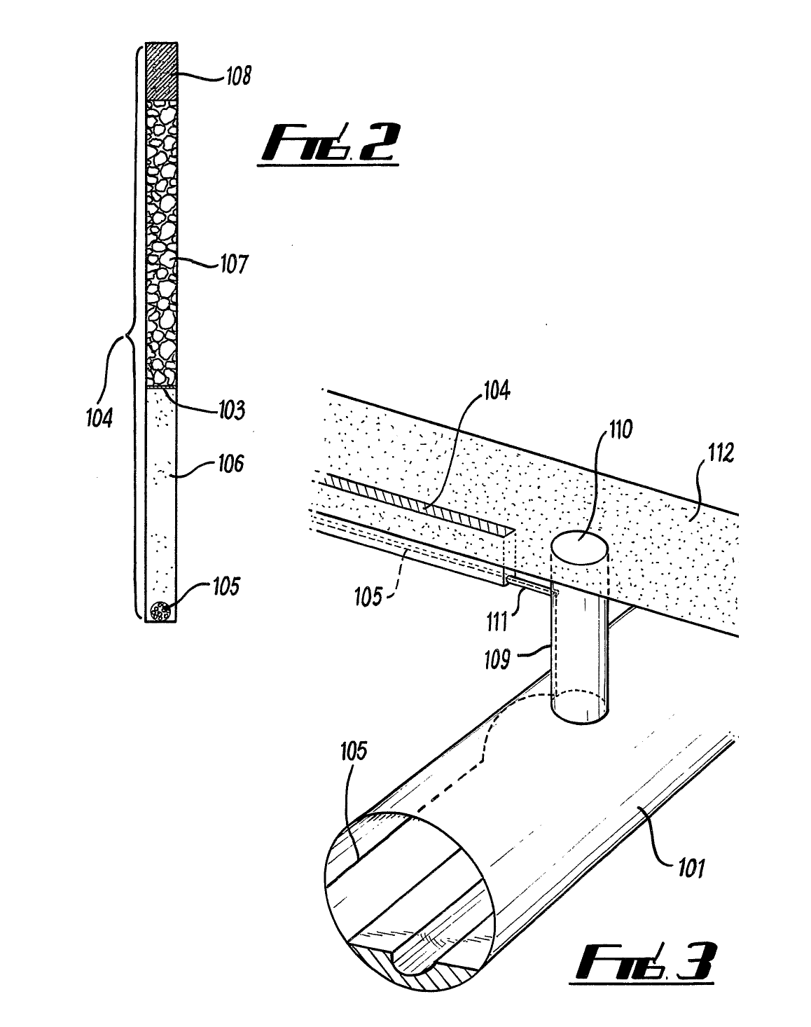

FIG. 2 illustrates how a cable may be laid in a trench rather than a sewer according to the present invention;

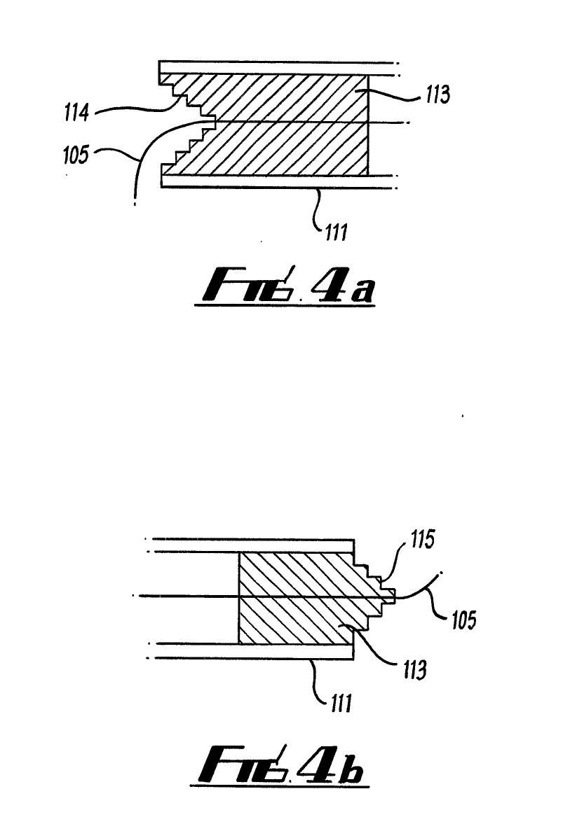

FIG. 3 is a schematic view illustrating the transition of a cable between sewer and trench;

FIG. 4a is a cross-sectional view of one end of a sealing means according to the present invention; and

FIG. 4b is a cross-sectional view of an alternative embodiment of one end of a sealing means according to the present invention.

Referring now to FIG. 1, a number of locations A-C are shown which may be connected by cables within a network. Also shown on FIG. 1 is a simple sewer network 100 comprising two branch sewers 101, 102 that meet at junction D.

According to the methods of the prior art, laying a network cable 105 between A and C would either involve providing a dedicated cable conduit, whether by cut and cover methods or otherwise; or would involve laying a cable 105 through sewer branch 101 to junction D and then along branch 102 to point C. In the present invention, there is a third possibility in that the cable 105 is laid along sewer branch 101 to point B and then travels through a dedicated conduit directly to point C. As the cost of laying cable through a sewer can be cheaper and is usually less disruptive than laying cable in a dedicated conduit, the method of the present invention may reduce the cost of providing a cable link in situations such as A-C wherein a convenient sewer extends only part way between the cable end points.

The cable 105 may be laid through the sewer system 100 by any convenient method, as is discussed further below.

Referring now to FIG. 2, one method of laying the cable 105 outside a sewer is shown. This is a cut and cover method that involves cutting a trench 104 and laying the cable 105 at the bottom of the trench 104. The cable 105 may be laid in a duct (not shown) provided in the bottom of the trench 104 or not, as desired. Typically, for data carrying cable, such as optical fibre cables, the trench is around 20-30 mm in width and around 400-600 min in depth.

The bottom 200 mm or so of the trench 104 are filled with sand 106 or similar. Optionally, a warning tape 103 may be laid on top of the sand layer 106. The warning tape is provided with metal strip inlay which may be detected by inductive detectors. Additionally, the tape may be brightly coloured and patterned such that it is easily located when digging.

Above the sand layer a layer of hardcore 107 is provided. This hard core layer is typically around 200-400 mm in depth. Above the hardcore layer 107 a layer of tarmac, asphalt, concrete or similar may be provided, to blend the trench 104 in with surroundings.

FIG. 3 illustrates schematically, how a cable 105 may pass between a sewer branch 101 and a trench 104 such as at position B in FIG. 1. In the drawing, the cable 105 is shown fixed to the side of the sewer 101, however it need not be fixed there and may in alternative solutions be fixed or laid freely in another position within the sewer 101. The cable 105 exits the sewer branch 101 along an access shaft 109 and then along a duct 111 into trench 104. In the example shown, the access shaft 109 is provided with a cover 110 and is situated in a road 112. The trench 104 is cut along the road 112.

Accordingly, the present invention thus provides means wherein a cable network may be laid partially through sewers 100 and partially via dedicated conduits where there are no convenient sewers. The invention may be applied to the construction of data transmission networks, as desired or as appropriate. The cables laid through sewers may be laid in any suitable manner. This could comprise the cables being pinned to a side wall of the sewer as illustrated schematically in FIG. 3. Alternatively, the cables could be laid along ducting installed or pre-installed in the sewer for the purpose. Another alternative would be to lay the cable unfixed along the flow channel of the sewer. In such cases, suitable cable guides could be provided to enable the cable to enter/exit the flow channel without undue hindrance to the flow and thus minimising the likelihood of causing a blockage. Cable guides could also be provided at points wherein the cables are desired to enter/leave the sewers altogether or on either side of junctions or bends in the sewer where loose-lying cable in the flow channel may lie across the direction of flow and potentially impede the flow.

In order to prevent the escape of noxious gases from the sewer 101 along duct 111, suitable sealing means 113 may be provided. The sealing means 113 is adapted to form a substantially airtight seal between its exterior surface and the interior surface of duct 111, as is shown in FIGS. 4a and 4b. The sealing means 113 is also provided with a central passageway through which cable 105 may pass. The passageway is adapted to form a substantially airtight seal around the cable 105. The sealing means 113 is formed from a resiliently deformable material, such that it can compensate for small irregularities on its exterior, on the interior of the duct 111, on the passageway or on the cable 105, to maintain a seal. In some embodiments, a suitable adhesive, such as an epoxy resin, may be applied to the exterior to help retain the sealing means 113 within duct 111. Additionally or alternatively, the adhesive may be applied in the passageway around cable 105 to help retain the cable 105 in place. The adhesive may also help maintain a substantially airtight seal where it is applied.

The ends of sealing means 113 may be adapted to make it easier to insert the cable 105 through the passageway or to make it easier to insert the sealing means 113 into the duct 111. In FIG. 4a, one possible adaptation provides a recessed stepped end portion 114 and in FIG. 4b one possible adaptation provides a projecting stepped end portion 115. Other suitable adaptations may of course be provided, if required or if desired. The sealing means may also be adapted to fit within any other apertures ducts or pipes providing a route by which a cable 105 may exit a sewer 101.

It is of course to be understood that the invention is not to be restricted to the details of the above embodiments which have been described by way of example only.

1-41. (canceled)

42. A method of laying a cable between two points comprising the steps of: laying a cable through lengths of sewer between the two points; and where there is no convenient length of sewer or a gap between convenient lengths of sewer, providing a length of dedicated cable conduit between said lengths of sewer and laying said cable through said dedicated cable conduit.

43. A method as claimed in claim 42 wherein the cable is laid through the sewer using any suitable technique including: laying the cable loose in the flow channel of the sewer; pinning the cable to the walls of the sewer; or passing the cable through a duct provided in the sewer.

44. A method as claimed in claim 43 wherein if the method involves laying the cable loose in the flow channel of a sewer, the method includes the step of installing a suitable cable guide at points wherein the cable is desired or required to enter or leave the flow channel, the cable guide adapted to enable the cable to enter/exit the flow channel without significantly impeding the flow.

45. A method as claimed in claim 44 wherein the cable guide comprises a body section and an arm section, the body section adapted to lie substantially flush with the wall of the flow channel and the arm section providing a passage for the cable between the flow channel and a point outside the flow channel.

46. A method as claimed in claim 44 wherein cable guides are installed at points wherein the cable is required to enter or leave the sewer and on either side of points such as junctions or bends in the sewer wherein a cable in the flow channel is likely to lie across the direction of flow.

47. A method as claimed in claim 46 wherein at points such as junctions or bends in the sewer wherein a cable in the flow channel is likely to lie across the direction of flow the cable is laid outside the flow channel using any suitable other technique such as pinning the cable to the walls of the sewer; or passing the cable through a duct provided in the sewer.

48. A method as claimed in claim 43 wherein if the method involves passing the cable through a duct provided in the sewer, the method may involve the additional step of installing a suitable duct.

49. A method as claimed in claim 42 wherein the cable conduit is provided by digging a trench, laying the cable in the trench and filling the trench.

50. A method as claimed in claim 49 wherein the cable is laid in ducting provided at the bottom of the trench.

51. A method as claimed in claim 49 wherein the trench is filled with a sand layer directly over the cable, a layer of hard core over the sand and a layer of concrete, tarmac, asphalt, bitumen or other suitable sealing/paving surface provided over the hard core.

52. A method as claimed in claim 51 wherein the method includes laying a warning tape between the sand and the hard core layers, the warning tape adapted to be detectable by the provision of a metal strip inlay and/or being printed with a visible warning, the visible warning comprising bright colours and/or distinctive patterns and/or a written warning message such as “Warning Fibre Cable”.

53. A method as claimed in claim 49 wherein the trench is cut and filled in line with the relevant provisions of the MCH 1540 (issue E) standard set by the UK Highways Agency for the installation of inductive loops in roads.

54. A method as claimed in claim 42 wherein the cable exits the sewer via a duct into the space below an access hatch or ‘manhole’.

55. A method as claimed in claim 42 wherein sealing means are provided at points wherein the cable exits a sewer, to prevent the escape of noxious gases from the sewer.

56. A method as claimed in claim 42 wherein sealing means are provided at both ends of a duct carrying the cable between the sewer and the dedicated conduit.

57. A method as claimed in claim 42 wherein cables are laid along the roadside drains and/or other types of storm drain in addition to or in place of cables laid along sewers.

58. A method as claimed in claim 42 further comprising a network of one or more cables.

59. A network as claimed in claim 58 wherein the network is used for any form of data.

60. A sealing means for preventing the escape of noxious gases from a sewer at a point wherein a cable exits said sewer comprising: a body having an exterior adapted to fit the aperture through which the cable exits the sewer; and a passage through the body allowing the passage of said cable wherein the body is formed from a resiliently deformable material such that it forms a substantially air tight seal around the cable and a substantially airtight seal between the exterior of the body and the aperture.

61. A sealing means as claimed in claim 60 wherein one or both ends of the sealing means are adapted to make it easier to insert a cable.

62. A sealing means as claimed in claim 61 wherein this is achieved by adapting one or both ends to provide a recessed stepped end portion.

63. A sealing means as claimed in claim 61 wherein this is achieved by adapting one or both ends to provide a projecting stepped end portion.

64. A sealing means as claimed in claim 60 wherein the sealing means are adapted to fit a duct leading the cable away from the sewer.

65. A sealing means as claimed in claim 64 wherein the sealing means are retained in the duct with the aid of a suitable adhesive and/or wherein the cable is retained in the sealing means with the aid of a suitable adhesive, the adhesive aiding the formation of a substantially airtight seal.

66. A sealing means as claimed in claim 60 comprising: a method of preventing the escape of noxious gases from a sewer at the point wherein a cable exits said sewer by installing a sealing means at the point wherein said cable exits said sewer.
